(19) United States
(12) Patent Application Publication
(10) Pub. No.: US 2005/0187341 A1
(43) Pub. Date: Aug. 25, 2005

(54) Process for the production of polyurethane di(meth)acrylates

(76) Inventors: Carmen Flosbach, Wuppertal (DE); Wiebke Becker, Essen (DE); Stefanie Matten, Wuppertal (DE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/782,098

(22) Filed: Feb. 19, 2004

(51) Int. Cl. C08K 3/00; C08L 75/00

(52) U.S. Cl. 524/589; 528/44

(57) ABSTRACT

A process for the production of polyurethane di(meth)acrylates in which 1,6-hexane diisocyanate is reacted, without solvent and without subsequent purification operations, with a diol component and hydroxy-C2-C4-alkyl (meth)acrylate in the molar ratio x:(x−1):2, wherein x means any desired value from 2 to 5 and the diol component is a combination of two to four (cyclo)aliphatic diols with molar masses of 62 to 600 and wherein each of the diols constitutes at least 10 mol % of the diols of the diol component and powder coating compositions having the polyurethane di(meth)acrylates as a binder.

### BACKGROUND OF THE INVENTION

1. Field of the Invention

The present invention relates to a process for the production of polyurethane di(meth)acrylates, to the polyurethane di(meth)acrylates produced by the process according to the invention and to powder coating compositions (powder coatings) which contain the polyurethane di(meth)acrylates as binders.

2. Description of the Prior Art

Polyurethane (meth)acrylates suitable as binders for the production of powder coating compositions are known from WO 01/25306. They are produced by reacting at least one linear aliphatic diisocyanate, at least one aliphatic compound with at least two isocyanate-reactive functional groups and/or water and at least one olefinically unsaturated compound with an isocyanate-reactive functional group. WO 01/25306 recommends performing the reaction in an organic solvent or solvent mixture which is not isocyanate-reactive. The polyurethane (meth)acrylate may then be obtained by evaporation and/or crystallization and/or recrystallization. All the syntheses described in the Examples section of WO 01/25306 proceed in methyl ethyl ketone as the inert solvent, followed by 12 hours cooling at 3° C. of the resultant product solution, from which polyurethane acrylate is isolated as a precipitated solid by suction filtration, washing and vacuum-drying.

While working in the organic solvent does indeed yield products usable as powder coating binders, it is disadvantageous in various respects. The solvent must be completely separated from the product to be used as powder coating binder. Yield is reduced by the purification operations.

Replication of the synthesis examples from WO 01/25306 in the absence of organic solvent is problematic either because excessively high melting temperatures must be used, resulting in the risk of thermal free-radical polymerization of the olefinic double bonds, or because products are obtained which are not suitable as powder coating binders because their melting point or melting range is too high or too low. Excessively low melting temperatures do not permit processing to form a powder coating; grinding, for example, is made more difficult or impossible. Excessively high melting temperatures are, for example, incompatible with powder coating processes which comprise a curing process in which lower melting temperatures are specified. Excessively high melting temperatures also often have a negative impact on levelling of the powder coating in the molten state during the curing process.

There was a desire to develop a process for the production of polyurethane (meth)acrylates suitable as powder coating binders which avoids the stated disadvantages.

The process according to the invention was accordingly developed, which proceeds in the absence of solvents and without loss of yield and provides polyurethane di(meth)acrylates which, even without purification, may successfully be used as powder coating binders.

### SUMMARY OF THE INVENTION

The process is a process for the production of polyurethane di(meth)acrylates in which 1,6-hexane diisocyanate is reacted, without solvent and without subsequent purification operations, with a diol component and hydroxy-C2-C4-alkyl (meth)acrylate, preferably hydroxy-C2-C4-alkyl acrylate, in the molar ratio x:(x−1):2, wherein x means any desired value from 2 to 5, preferably from 2 to 4, and the diol component is a combination of two to four, preferably of two or three (cyclo)aliphatic diols with molar masses of 62 to 600 and wherein each of the diols constitutes at least 10 mol % of the diols of the diol component.

### DETAILED DESCRIPTION OF THE EMBODIMENTS

In the process according to the invention, 1,6-hexane diisocyanate, diol component and hydroxyalkyl (meth)acrylate are reacted stoichiometrically with one another in the molar ratio x mol 1,6-hexane diisocyanate: (x−1) mol diol:2 mol hydroxyalkyl (meth)acrylate, wherein x means any desired value from 2 to 5, preferably from 2 to 4. At values of x>5, it is often necessary to use synthesis temperatures which are so high that there is a risk of free-radical polymerization during the synthesis and/or products are obtained which, with regard to use as powder coating binders, have excessively high melting points or ranges, for example, above 120° C. Moreover, it is, in general, not possible to achieve adequate crosslink density with powder coatings formulated with polyurethane di(meth)acrylates as binders that have been produced at x>5.

Combinations of two to four, preferably of two or three (cyclo)aliphatic diols with molar masses of 62 to 600 are used as the diol component. It is not expedient to use diols with higher molar masses as polyurethane di(meth)acrylates are obtained which cannot be processed readily or at all to yield powder coatings, in particular cannot be ground (milled). As has already been explained in relation to the replication of the synthesis examples of WO 01/25306, using only a single diol instead of the above-stated diol component results in the formation of polyurethane di(meth)acrylates which are unsuitable as powder coating binders or which require excessively high temperatures during synthesis.

In the synthesis process, according to the invention, the diol component may be introduced as a mixture of its constituent diols or the diols constituting the diol component may be introduced individually into the synthesis. It is also possible to introduce a proportion of the diols as a mixture and to introduce the remaining proportion or proportions in the form of pure diol. Each of the diols constitutes at least 10 mol % of the diols of the diol component.

Examples of (cyclo)aliphatic diols which are possible constituents of the diol component are ethylene glycol, the isomeric propane- and butanediols, 1,5-pentanediol, 1,6-hexanediol, 1,10-decanediol, 1,12-dodecanediol, neopentyl glycol, butylethylpropanediol, the isomeric cyclohexanediols, the isomeric cyclohexanedimethanols, hydrogenated bisphenol A, tricyclodecanedimethanol, and dimer fatty alcohol.

Preferred diol components are combinations, in each case amounting to 100 mol % in total, of 20 to 80 mol % hydrogenated bisphenol A with 80 to 20 mol % 1,10-decanediol, 20 to 80 mol % hydrogenated bisphenol A with 80 to 20 mol % 1,6-hexanediol, 60 to 90 mol % neopentyl glycol with 40 to 10 mol % 1,6-hexanediol, 10 to 90 mol % cyclohexanedimethanol with 90 to 10 mol % 1,5-pentanediol and three-component combinations comprising in each case 10 to 50 mol % 1,3-propanediol, 1,5-pentanediol and 1,6-hexanediol and in each case 10 to 50 mol % 1,3-propanediol, 1,5-pentanediol and cyclohexanedimethanol.

Preferably, only one hydroxy-C2-C4-alkyl (meth)acrylate is used in the process according to the invention. Examples of hydroxy-C2-C4-alkyl (meth)acrylates are hydroxyethyl (meth)acrylate, one of the isomeric hydroxypropyl (meth)acrylates or one of the isomeric hydroxybutyl (meth)acrylates; the acrylate compound is preferred in each case.

In the process according to the invention, 1,6-hexane diisocyanate, diols of the diol component and hydroxy-C2-C4-alkyl (meth)acrylate are reacted together without solvents. The reactants may here all be reacted together simultaneously or in two or more synthesis stages. When the synthesis is performed in multiple stages, the reactants may be added in the most varied order, for example, also in succession or in alternating manner. For example, 1,6-hexane diisocyanate may be reacted initially with hydroxy-C2-C4-alkyl (meth)acrylate and then with the diols of the diol component or initially with the diols of the diol component and then with hydroxy-C2-C4-alkyl (meth)acrylate. However, the diol component may, for example, also be divided into two or more portions, for example, also into the individual diols, for example, such that 1,6-hexane diisocyanate is initially reacted with part of the diol component before further reaction with hydroxy-C2-C4-alkyl (meth)acrylate and finally with the remaining proportion of the diol component. The individual reactants may in each case be added in their entirety or in two or more portions. The reaction is exothermic and proceeds at a temperature above the melting temperature of the reaction mixture, but below a temperature, which results in free-radical polymerization of the (meth)acrylate double bonds. The reaction temperature is, for example, between 60 and 120° C. The rate of addition or quantity of reactants added is accordingly determined on the basis of the degree of exothermy and the liquid (molten) reaction mixture may be maintained within the desired temperature range by heating or cooling.

Once the reaction is complete and the reaction mixture has cooled, solid polyurethane di(meth)acrylates with calculated molar masses in the range from 630 or higher, for example, up to 2000, are obtained. The polyurethane di(meth)acrylates assume the form of a mixture exhibiting a molar mass distribution, optionally also as a mixture with the adduct, formed as a secondary product, of one molecule of 1,6-hexane diisocyanate and two molecules of hydroxy-C2-C4-alkyl (meth)acrylate. The polyurethane di(meth)acrylates do not, however, require working up and may be used directly as a powder coating binder. Their melting temperatures are in particular in the range from 80 to 120° C.; in general, the melting temperatures are not sharp melting points, but instead the upper end of melting ranges with a breadth of, for example, 30 to 90° C.

The polyurethane di(meth)acrylates may be used in powder coatings not only as the sole binder or as the main binder constituting at least 50 wt. % of the resin solids content, but also in smaller proportions as a co binder.

The powder coatings produced with the polyurethane di(meth)acrylates produced according to the invention as the powder coating binders may comprise powder coatings curable exclusively by the free-radical polymerization of olefinic double bonds, which cure thermally or by irradiation with high-energy radiation, in particular UV radiation. They may, however, also comprise “dual-cure” powder coatings, which additionally cure by means of a further, in general thermally induced crosslinking mechanism.

Depending on the nature of the powder coatings, the resin solids content thereof may apart from the polyurethane di(meth)acrylates produced according to the invention also contain further binders and/or crosslinking agents. The further binders and/or crosslinking agents may here be curable thermally and/or by irradiation with high-energy radiation.

While thermally curable powder coatings contain thermally cleavable free-radical initiators, the powder coatings curable by UV irradiation contain photoinitiators.

Depending on the selected curing conditions (purely thermal curing or a combination of UV irradiation and thermal curing), dual-cure powder coatings may contain thermally cleavable free-radical initiators or photoinitiators.

Examples of thermally cleavable free-radical initiators are azo compounds, peroxide compounds and C—C-cleaving initiators.

Examples of photoinitiators are benzoin and derivatives thereof, acetophenone and derivatives thereof, such as, for example, 2,2-diacetoxyacetophenone, benzophenone and derivatives thereof, thioxanthone and derivatives thereof, anthraquinone, 1-benzoylcyclohexanol, organophosphorus compounds, such as, for example, acyl phosphine oxides.

The initiators for curing by free-radical polymerization are used, for example, in proportions of 0.1 to 7 wt. %, preferably of 0.5 to 5 wt. %, relative to the total of resin solids content and initiators. The initiators may be used individually or in combination.

Apart from the already stated initiators, the powder coatings may contain further conventional coating additives, for example, inhibitors, catalysts, levelling agents, degassing agents, wetting agents, anticratering agents, antioxidants and light stabilizers. The additives are used in conventional amounts known to the person skilled in the art.

The powder coatings may also contain transparent pigments, color-imparting and/or special effect-imparting pigments and/or fillers (extenders), for example, corresponding a pigment plus filler: resin solids content ratio by weight in the range from 0:1 to 2:1. Examples of inorganic or organic color-imparting pigments are titanium dioxide, iron oxide pigments, carbon black, azo pigments, phthalocyanine pigments, quinacridone or pyrrolopyrrole pigments. Examples of special effect-imparting pigments are metal pigments, for example, made from aluminum, copper or other metals; interference pigments, such as, for example, metal oxide coated metal pigments, for example, titanium dioxide coated or mixed oxide coated aluminum, coated mica, such as, for example, titanium dioxide coated mica. Examples of usable fillers are silicon dioxide, aluminum silicate, barium sulfate, calcium carbonate and talcum.

The powder coatings may be produced using the conventional methods known to the person skilled in the art, in particular, for example, by extruding the powder coating, which has already been completely formulated by dry mixing of all the required components, in the form of a pasty melt, cooling the melt, performing coarse comminution, fine grinding and then sieving to the desired grain fineness, for example, to average particle sizes of 20 to 90 μm.

The powder coatings may be used for any desired industrial coating purpose and are applied using conventional methods, preferably by spraying. Substrates which may be considered are in particular not only metal substrates but also plastic parts, for example, also fibre-reinforced plastic parts. Examples are automotive bodies and body parts, such as, for example, body fittings.

The powder coatings preferably comprise powder clear coating compositions, which are used to produce an outer powder clear coat layer on a color- and/or special effect-imparting base coat layer. For example, a color—and/or special effect-imparting base coat layer may be applied onto automotive bodies provided with a conventional precoating and optionally cured and thereafter a powder clear coat layer of the powder clear coating composition may be applied and cured. If the base coat layer is not cured before application of the powder clear coat, the powder clear coat is applied by the “wet-on-wet” process.

The method used to apply the powder coatings may be, for example, initially to apply the powder coating onto the particular substrate and to melt it by heating the applied powder coating to a temperature above the melting temperature, for example, in the range from 80 to 150° C. After melting with exposure to heat, for example, by convective and/or radiant heating, and an optionally provided phase to allow for levelling, curing may proceed by irradiation with high-energy radiation and/or by supply of thermal energy. UV radiation or electron beam radiation may be used as high-energy radiation. UV radiation is preferred.

The following examples illustrate the invention. As used below, “pbw” means parts by weight.

### EXAMPLES

### Examples 1-24

Polyurethane diacrylates were produced by reacting 1,6-hexane diisocyanate with diols and hydroxyalkyl acrylate in accordance with the following general synthesis method:

1,6-hexane diisocyanate (HDI) was initially introduced into a 2 litre four-necked flask equipped with a stirrer, thermometer and column and 0.1 wt. % methylhydroquinone and 0.01 wt. % dibutyltin dilaurate, in each case relative to the initially introduced quantity of HDI, were added. The reaction mixture was heated to 60° C. Hydroxyalkyl acrylate was then apportioned in such a manner that the temperature did not exceed 80° C. The reaction mixture was stirred at 80° C. until the theoretical NCO content had been reached. Once the theoretical NCO content had been reached, the diols A, B, C were added one after the other, in each case in a manner such that a temperature of 75 to 120° C. was maintained. In each case, the subsequent diol was not added until the theoretical NCO content had been reached. The reaction mixture was stirred at 120° C. until no free isocyanate could any longer be detected. The hot melt was then discharged and allowed to cool.

In the case of Examples 18 to 24, the synthesis could not be taken to completion and had to be terminated as, due to the elevated melting temperature of the resultant product, the temperature of the reaction mixture during the synthesis would have had to exceed >120° C.

In the case of Examples 1 to 17, it was possible to take the reaction successfully to completion in each case. The melting behavior of the resultant polyurethane diacrylates was investigated by means of DSC (differential scanning calorimetry, heating rate 10 K/min). The polyurethane diacrylates of Examples 12 to 14 as well as 16 and 17 were not usable as powder coating binders because they were not grindable (flowable at room temperature, waxy consistency or excessively low melting temperature).

Using the polyurethane diacrylates of Examples 1 to 11 (each according to the invention) and 15 as binders, it proved possible to produce, apply and cure powder coatings in accordance with the following general method, wherein in each case, apart from Example 15, adequate crosslink density was achieved (determined by swab testing with methyl ethyl ketone):

A comminuted mixture of the following components was premixed and extruded
96.5 pbw of one of the polyurethane diacrylates of Examples 1 to 11 or 15,
1 pbw of Irgacure® 2959 (photoinitiator from Ciba),
0.5 pbw of Powdermate® 486 CFL (levelling additive from Troy Chemical Company),
1 pbw of Tinuvin® 144 (HALS light stabilizer from Ciba) and
1 pbw of Tinuvin® 405 (UV absorber from Ciba)
   to produce a powder coating in conventional manner after cooling, crushing, grinding and sieving.

The powder coating was sprayed onto a steel test panel to a layer thickness of 50 μm, melted for 10 min at 140° C. (oven temperature) and cured by UV irradiation corresponding to a radiation intensity of 500 mW/cm² and a radiation dose of 800 mJ/cm².

Examples 1 to 24 are shown in Table 1. The Table states which reactants were reacted together in what molar ratios and the result which was achieved. In particular, where sensibly possible, the final temperature of the melting process measured by DSC is stated in ° C.

TABLE 1

| | | Moles | | | | |
|---|---|---|---|---|---|---|
| | | Hydroxy- | | | | |
| | Moles | alkyl | Moles | Moles | Moles | |
| Example | HDl | acrylate | diol A | diol B | diol C | Results |
| 1 | 2 | 2 HEA | 0.8 NPG | 0.2 HEX | | 90° C.; grindable |
| | | | | | | chilled |
| 2 | 3 | 2 HEA | 1.7 NPG | 0.3 HEX | | 88° C.; grindable |
| | | | | | | chilled |
| 3 | 3 | 2 HEA | 1.5 NPG | 0.5 HEX | | 99° C.; grindable |
| 4 | 4 | 2 HEA | 2.2 NPG | 0.8 HEX | | 100° C.; grindable |
| 5 | 3 | 2 HEA | 1 HBPA | 1 HEX | | 110° C.; grindable |
| 6 | 3 | 2 HEA | 1 HBPA | 1 DEK | | 118° C.; grindable |
| 7 | 3 | 2 HBA | 0.7 MPD | 0.7 PENT | 0.6 | 117° C.; grindable |
| | | | | | DEK | |
| 8 | 3 | 2 HBA | 1 CHDM | 1 PROP | | 118° C.; grindable |
| 9 | 3 | 2 HBA | 1.3 CHDM | 0.7 PENT | | 120° C.; grindable |
| 10 | 3 | 2 HPA | 1 CHDM | 0.5 PROP | 0.5 | 118° C.; grindable |
| | | | | | PENT | |
| 11 | 3 | 2 HPA | 0.6 HEX | 0.7 PENT | 0.7 | 112° C.; grindable |
| | | | | | PROP | |
| 12 | 5 | 2 HBA | 4 NPG | | | flows at room |
| | | | | | | temperature |
| 13 | 4 | 2 HEA | 2.9 NPG | 0.1 HEX | | flows at room |
| | | | | | | temperature |
| 14 | 3 | 2 HPA | 1.8 CAPA | 0.2 HEX | | waxy, not grindable |
| 15 | 6 | 2 HEA | 4 NPG | 1 HEX | | 99° C.; inadequate |
| | | | | | | crosslink density |
| 16 | 2 | 2 HPA | 1 HBPA | | | 84° C.; not grindable |
| 17 | 3 | 2 HBA | 2 | | | 72° C.; not grindable |
| | | | 1,3-BD | | | |
| 18 | 4 | 2 HBA | 3 HEX | | | synthesis terminated |
| 19 | 3 | 2 HPA | 2 DEK | | | synthesis terminated |
| 20 | 3 | 2 HPA | 2 MPD | | | synthesis terminated |
| 21 | 3 | 2 HEA | 2 PROP | | | synthesis terminated |
| 22 | 3 | 2 HEA | 2 PENT | | | synthesis terminated |
| 23 | 3 | 2 HEA | 2 CHDM | | | synthesis terminated |
| 24 | 3 | 2 HBA | 2 | | | synthesis terminated |
| | | | 1,4-BD | | | |

HDI: 1,6-hexane diisocyanate
HBA: 4-hydroxybutyl acrylate
HEA: hydroxyethyl acrylate
HPA: 2-hydroxypropyl acrylate
1,3-BD: 1,3-butanediol
1,4-BD: 1,4-butanediol
CAPA: polycaprolactonediol with a hydroxyl value of 112 mg of KOH/g
CHDM: 1,4-cyclohexanedimethanol
DEK: 1,10-decanediol
HBPA: hydrogenated bisphenol A
HEX: 1,6-hexanediol
MPD: 2-methyl-1,3-propanediol
NPG: neopentyl glycol
PENT: 1,5-pentanediol
PROP: 1,3-propanediol

1. A process for the production of polyurethane di(meth)acrylates in which 1,6-hexane diisocyanate is reacted, without solvent and without subsequent purification operations, with a diol component and hydroxy-C2-C4-alkyl (meth)acrylate in the molar ratio x:(x−1):2, wherein x means any desired value from 2 to 5 and the diol component is a combination of two to four (cyclo)aliphatic diols with molar masses of 62 to 600 and wherein each of the diols constitutes at least 10 mol % of the diols of the diol component.

2. The process of claim 1, wherein the diols of the diol component are selected from the group consisting of ethylene glycol, the isomeric propane- and butanediols, 1,5-pentanediol, 1,6-hexanediol, 1,10-decanediol, 1,12-dodecanediol, neopentyl glycol, butylethylpropanediol, the isomeric cyclohexanediols, the isomeric cyclohexanedimethanols, hydrogenated bisphenol A, tricyclodecanedimethanol and dimer fatty alcohol.

3. The process of claim 1, wherein the diol component is selected from the group consisting of combinations of 20 to 80 mol % hydrogenated bisphenol A with 80 to 20 mol % 1,10-decanediol, 20 to 80 mol % hydrogenated bisphenol A with 80 to 20 mol % 1,6-hexanediol, 60 to 90 mol % neopentyl glycol with 40 to 10 mol % 1,6-hexanediol, 10 to 90 mol % cyclohexanedimethanol with 90 to 10 mol % 1,5-pentanediol and three-component combinations comprising in each case 10 to 50 mol % 1,3-propanediol, 1,5-pentanediol and 1,6-hexanediol and in each case 10 to 50 mol % 1,3-propanediol, 1,5-pentanediol and cyclohexanedimethanol, wherein the mol percentages add up to 100 mol % in each of the combinations.

4. Polyurethane di(meth)acrylates produced using the process of claim 1.

5. Polyurethane di(meth)acrylates produced using the process of claim 2.

6. Polyurethane di(meth)acrylates produced using the process of claim 3.

7. Powder coating compositions containing the polyurethane di(meth)acrylates produced according to the process of claim 1 as binder.

8. Powder coating compositions containing the polyurethane di(meth)acrylates produced according to the process of claim 2 as binder.

9. Powder coating compositions containing the polyurethane di(meth)acrylates produced according to the process of claim 3 as binder.

10. A substrate coated with a layer of the powder coating composition according to claim 7.
